(19) United States
(12) Patent Application Publication
(10) Pub. No.: US 2020/0025274 A1
(43) Pub. Date: Jan. 23, 2020

(54) SHOCK ABSORBER SERVICE LIFE SENSOR

(71) Applicant: RIDE CONTROL, LLC, Farmington Hills, MI (US)

(72) Inventors: Gerald D. ANDERSON, Oxford, MI (US); Gregory P. BEACH, Farmington Hills, MI (US); Sesha Jayateja PEERAMSETTY, West-Bloomfield, MI (US); Tejas PUNTAMBEKAR, Farmington Hills, MI (US); Yi HAN, Wixom, MI (US); Joseph P. SULLIVAN, Plymouth, MI (US)

(21) Appl. No.: 16/514,757

(22) Filed: Jul. 17, 2019

Related U.S. Application Data
(60) Provisional application No. 62/700,552, filed on Jul. 19, 2018.

(51) Int. Cl. F16F 9/32

(52) U.S. Cl. CPC F16F 9/3292; F16F 2222/12; F16F 2230/0047; F16F 2230/0005

(57) ABSTRACT

A system for monitoring the health of a damping device is provided, the damping device having a tube assembly containing at least one fluid, the system including: a sensor assembly mounted on an outer surface of the tube assembly, the sensor assembly having a thermometer; a transmitter configured for transmitting data, including temperature values gathered by the thermometer; a receiver configured for receiving the data; and a processor, configured for performing an analysis of the data. The processor sends an alarm signal, when values from the data are outside pre-programmed values of an alarm threshold.

### RELATED APPLICATION

This application is a Non-Provisional of, and claims 35 USC 119 priority from, U.S. Provisional Ser. No. 62/700,552 filed Jul. 19, 2018, which is incorporated by reference.

### BACKGROUND

The present disclosure relates generally to systems for monitoring the efficiency of mechanical devices that operate by converting kinetic energy to heat. More specifically, the present disclosure relates to a system for monitoring the health of damping devices, such as shock absorbers.

A common problem of conventional shock absorbers is that their life span depends on a variety of external factors. For applications such as automobiles, these factors include changes in weather patterns, the terrain over which the vehicle commonly travels, and the habits of each individual driver. There is a need by operators of fleets of vehicles, automobiles or trucks, of a reliable system for determining when shock absorbers need replacement.

### SUMMARY

Thus, there is a need for a system for monitoring the health of a damping device, such as an automotive shock absorber. This need is addressed by the present monitoring system, which in the preferred embodiment features a temperature sensor and an optional accelerometer, and is thus able to determine if the damping device is efficiently converting the kinetic energy of a moving shock tube assembly into heat.

More specifically, the present system monitors the health of a damping device, wherein the damping device has a telescoping tube assembly including a moving tube reciprocating relative to a fixed tube, the assembly containing at least one fluid. The system incorporates a sensor assembly mounted on an outer surface of the tube assembly, and the sensor assembly contains at least an accelerometer, a thermometer, and a first transmitter. The first transmitter is configured for transmitting a first data set, and the first data set holds acceleration values gathered by the accelerometer. The first transmitter is also configured to transmit a second data set, and that second data set holds temperature values gathered by the thermometer.

The system has a receiver, which is configured to receive the data from each of the thermometer and the accelerometer, as well as a processor. The processor is configured to perform an analysis of the thermometer and accelerometer data, including comparing corresponding values between the sensed data and pre-programmed values.

In an embodiment, the system sends an alarm signal when sensed values are outside the pre-programmed amounts. With respect to temperature, the alarm is triggered when the sensed temperature is below or otherwise outside pre-programmed values.

A system for monitoring the health of a damping device is provided, the damping device having a tube assembly containing at least one fluid, the system including: a sensor assembly mounted on an outer surface of the tube assembly, the sensor assembly having a thermometer; a transmitter configured for transmitting data, including temperature values gathered by the thermometer; a receiver configured for receiving the data; and a processor, configured for performing an analysis of the data. The processor sends an alarm signal, when values from the data are outside pre-programmed values of an alarm threshold.

In another embodiment, a damping device is provided, including a fixed outer tube, an inner tube reciprocating relative to the outer tube and having an outer surface, and a sensor assembly affixed to the outer surface of the inner tube.

### BRIEF DESCRIPTION OF THE DRAWINGS

FIG. 1 is a side view of an example damping device having a sensor assembly; and

FIG. 2 is a diagram showing connections between various elements of the present monitoring system.

### DETAILED DESCRIPTION

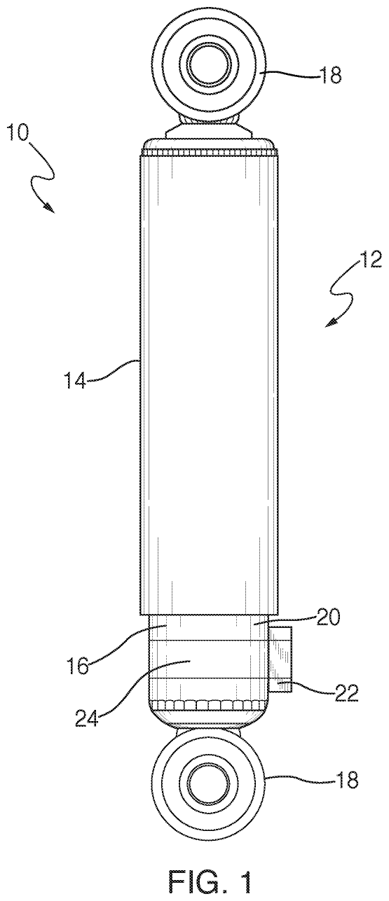

Referring now to FIG. 1, a damping device such as a shock absorber is shown and generally designated 10. The damping device 10 includes a tube assembly 12 including a fixed, outer tube 14 and a reciprocating, telescoping inner tube 16 as is well known in the art. Each of the tubes 14, 16 includes a corresponding eyelet 18 for mounting the respective tube to components of a vehicle, such as to the frame and to a moving suspension member (not shown). The tube assembly 12 contains at least one fluid (not shown), such as hydraulic fluid, or compressible gas, as is known in the art. Affixed to an outer surface 20 of the inner tube 16 is a sensor assembly 22. While the sensor assembly 22 is shown affixed to the inner tube 16 by a strap or band 24, other known fastening technologies are contemplated, including threaded fasteners and/or chemical adhesive, provided they can withstand the rigorous operational environment of vehicle shock absorbers.

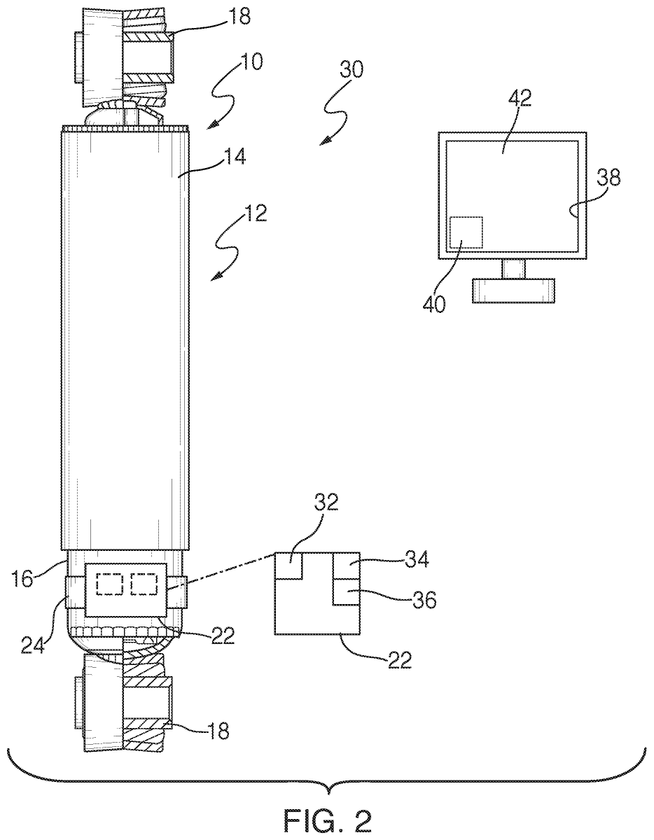

Turning next to FIG. 2, the damping device 10 of FIG. 1 is preferably employed in a system for monitoring the health of a damping device, generally designated 30. In the preferred embodiment, the sensor assembly 22 includes a temperature sensor or thermometer 32, an accelerometer 34, a first transmitter 36, and a battery (not shown). In a preferred embodiment, the transmitter 36 is a wireless transmitter, however hard wired transmitters are contemplated, depending on the application. The temperature sensor 32 and the accelerometer 34 are electronically connected to the transmitter 36, such that the transmitter transmits data from both the temperature sensor and the accelerometer to a receiver 38. In a preferred embodiment, the receiver 38 is a wireless receiver, however hard wired receivers are also contemplated, depending on the application.

It is also preferred that the sensor assembly 22 is an integrated circuit or programmable processor with modules or sub-circuits representing the temperature sensor 32, the accelerometer 34 and the transmitter 36.

The receiver 38 is electrically connected to a processor 40, which is configured for analyzing data transmitted by the transmitter 36. In a preferred embodiment, this data takes the form of two data sets, a first set holding data from the temperature sensor 32, and a second set holding data from the accelerometer 34. It is contemplated that, in a preferred embodiment, the temperature sensor 32 and the accelerometer 34 measure their respective temperature and acceleration values at the same point in time. The processor 40 is constructed and arranged for comparing corresponding points between each of the two data sets. In a preferred embodiment, while other frequencies are contemplated, the temperature sensor 32 and the accelerometer 34 each make measurements at a frequency of 3 Hertz.

In addition, the processor 40 is configured for analyzing the data received by the receiver 38. In a preferred embodiment, this analysis is a comparison of corresponding values between the two data sets.

As the damping device 10 operates, kinetic energy imparted to the device is decreased, thus damping the oscillation of components connected to the damping device. That kinetic energy is converted to heat through an increase in pressure of at least one fluid in the tube assembly 12. Thus, if the damping device 10 is operating correctly, values measured by the accelerometer 34 correspond to changes in the heat energy produced by the damping device. This heat energy is dissipated through the outer surface 20 of the inner tube 16, and is monitored by the temperature sensor.

By using the processor 40 to compare values measured by the temperature sensor 32 and the accelerometer 34 with pre-programmed values in a conventional look-up table, as is known in the processor art, the system 30 determines whether the damping device 10 is functioning correctly. If the temperature values registered by temperature sensor 32 are beneath pre-programmed alarm threshold, that alarm threshold being calculated from the acceleration values measured by accelerometer 34, then the damping device 10 is not functioning efficiently. This indicates that the damping device 10 is unhealthy, and is in need of repair or replacement.

In a preferred embodiment, when the analysis performed by processor 40 indicates that the damping device 10 is unhealthy, the processor 40 sends an alarm signal, which is contemplated as being visual and optionally audible to display 42. The display 34 shows a visual condition of the damping device 10, indicating that the system 30 has found a fault in the damping device.

It is also contemplated that the system 30 is connected to a CPU system (not shown). For automotive applications, this CPU system is connected to an OBDII port, or similar diagnostics output (not shown), such that a mechanic is able to monitor the health of the damping device 10 as part of a service. Persons having ordinary skill in the art will appreciate that the damping device health monitored by the system 30 is useful in a variety of applications, none of which depart from the scope of this disclosure.

Another feature of the present system 30 is that a switch 44 is provided so that the operator can manually disconnect the system to save the life of the battery in the sensor assembly 22. It is contemplated that the display 42 and the switch 44 are preferably located in a cab and/or on a dashboard of the vehicle for ready access by the vehicle operator.

While a particular embodiment of the shock absorber health monitoring system has been described herein, it will be appreciated by those skilled in the art that changes and modifications may be made thereto without departing from the invention in its broader aspects and as set forth in the following claims.

What is claimed is:

1. A system for monitoring the health of a damping device, the damping device having a tube assembly containing at least one fluid, the system comprising:
a sensor assembly mounted on an outer surface of said tube assembly, the sensor assembly comprising:
a thermometer;
a transmitter configured for transmitting data, comprising temperature values gathered by said thermometer;
a receiver configured for receiving said first data set;
a processor, configured to perform an analysis of said first data set, sending an alarm signal, when values from said data set are outside pre-programmed values of an alarm threshold.

2. The system of claim 2, further including an accelerometer included in said sensor assembly, and said analysis by said processor comprising comparing corresponding values generated by said accelerometer with pre-programmed values.

3. The system of claim 1, wherein the first transmitter is a wireless transmitter and said first receiver is a wireless receiver.

4. The system of claim 1, further including a display connected to said processor for displaying said alarm signal.

5. The system of claim 1, further including a switch connected to said processor, for disabling said system periodically for power conservation.

6. A damping device, comprising:
a fixed outer tube;
an inner tube reciprocating relative to said outer tube and having an outer surface;
a sensor assembly affixed to said outer surface of said inner tube.

7. The device of claim 6, wherein said sensor assembly includes a temperature sensor, an accelerometer and a transmitter.

8. The device of claim 6, wherein said sensor assembly is affixed to said inner tube by a band.
